(19) United States
(12) Patent Application Publication
(10) Pub. No.: US 2026/0301230 A1
(43) Pub. Date: Oct. 1, 2026

(54) CREASE ATTRIBUTE CODING

(71) Applicant: TENCENT AMERICA LLC, Palo Alto, CA (US)

(72) Inventors: Fang-Yi CHAO, Dublin (IE); Chao HUANG, Palo Alto, CA (US); Shan LIU, Palo Alto, CA (US)

(73) Assignee: TENCENT AMERICA LLC, Palo Alto, CA (US)

(21) Appl. No.: 19/409,862

(22) Filed: Dec. 5, 2025

Related U.S. Application Data
(60) Provisional application No. 63/777,260, filed on Mar. 25, 2025.
(60) Provisional application No. 63/811,486, filed on May 23, 2025.

(51) Int. Cl. G06T 9/00; G06T 9/20; H04N 19/70

(52) U.S. Cl. CPC G06T 9/001; G06T 9/20; H04N 19/70

(57) ABSTRACT

An encoding method performed by at least one processor includes receiving a polygon mesh comprising at least one crease; determining one or more predictors to predict a vertex of the at least one crease, each predictor corresponding to a vertex connected to a last previously encoded vertex in the at least one crease; and generating a bitstream comprising the polygon mesh and the one or more predictors.

### CROSS-REFERENCE TO RELATED APPLICATION

This application claims priority from U.S. Provisional Application No. 63/777,260 filed on Mar. 25, 2025, and U.S. Provisional Application No. 63/811,486 filed on May 23, 2025, the disclosure of each of which are incorporated herein by reference in their entirety.

### FIELD

This disclosure is directed to prediction methods for the vertices in crease attributes.

### BACKGROUND

The crease attribute, or line attribute, is one of the essential attributes in a 3D mesh that identifies edges to be creased. Crease attributes are specified by a series of vertex indices that denote the successive edges creased by a specific sharpness. For example crease information is specified by a set of point indices grouped successively to identify edges to be creased by a certain sharpness. Since the OBJ format does not have direct support for crease information, we propose novel description methods that efficiently represent the crease information in a mesh. Note that our methods can be applied not only to OBJ but also to other formats (e.g., PLY).

### SUMMARY

According to an aspect of the disclosure, an encoding method performed by at least one processor includes receiving a polygon mesh comprising at least one crease; determining one or more predictors to predict a vertex of the at least one crease, each predictor corresponding to a vertex connected to a last previously encoded vertex in the at least one crease; and generating a bitstream comprising the polygon mesh and the one or more predictors.

According to an aspect of the disclosure, a decoding method performed by at least one processor includes receiving a bitstream comprising a polygon mesh and one or more predictors; for predicting a vertex in at least one crease; polygon mesh comprising at least one crease; decoding a first vertex in at least one crease in the polygon mesh; decoding the one or more predictors based on connected vertices of the first vertex; determining a residue based on the one or more predictors; and reconstructing a second vertex in the at least one crease by adding the residue to the first vertex.

According to an aspect of the disclosure, a non-transitory computer readable medium storing a bitstream that is generated by an encoding method including receiving a polygon mesh comprising at least one crease; determining one or more predictors to predict a vertex of the at least one crease, each predictor corresponding to a vertex connected to a last previously encoded vertex in the at least one crease; and generating the bitstream comprising the polygon mesh and the one or more predictors.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a block diagram of a communication system, in accordance with embodiments of the present disclosure.

FIG. 2 is a schematic illustration of a block diagram of a streaming system, in accordance with embodiments of the present disclosure.

FIG. 3 is a schematic illustration of an example mesh encoder, in accordance with embodiments of the present disclosure.

FIG. 4 is an example of crease/line attributes, in accordance with embodiments of the present disclosure.

FIG. 5 is an example of crease/line attributes, in accordance with embodiments of the present disclosure.

FIG. 6 is an example of reordering of crease/line attributes, in accordance with embodiments of the present disclosure.

FIG. 7 is an example of crease attributes before and after grouping, in accordance with embodiments of the present disclosure.

FIG. 8 is an example of syntax for encoding a predictor index, in accordance with embodiments of the present disclosure.

FIG. 9 is an example of a first vertex as a predictor, in accordance with embodiments of the present disclosure.

FIG. 10 is an example vertex with multiple predictors, in accordance with embodiments of the present disclosure.

FIG. 11 is an example vertex with multiple predictors, in accordance with embodiments of the present disclosure.

FIG. 12 is an example ordering vertices connected to a last encoded vertex, in accordance of the present disclosure.

FIG. 13 is example vertex with multiple predictors, in accordance with embodiments of the present disclosure.

FIG. 14 is an example process for decoding a predictor, in accordance with embodiments of the present disclosure.

FIG. 15 is an example process for computing a predictor, in accordance with embodiments of the present disclosure.

FIG. 16 illustrates example results based on the embodiments of the present disclosure.

FIG. 17 illustrates example results based on embodiments of the present disclosure.

FIG. 18 illustrates an example computer diagram, in accordance with embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

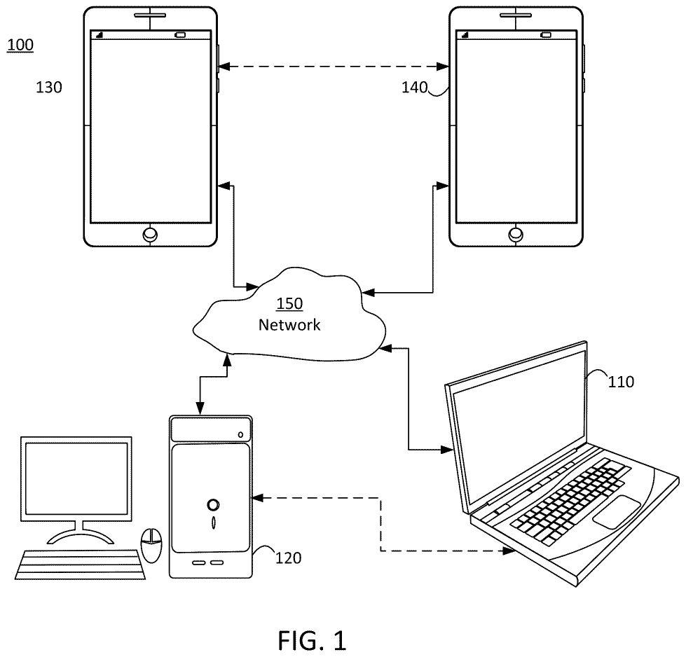

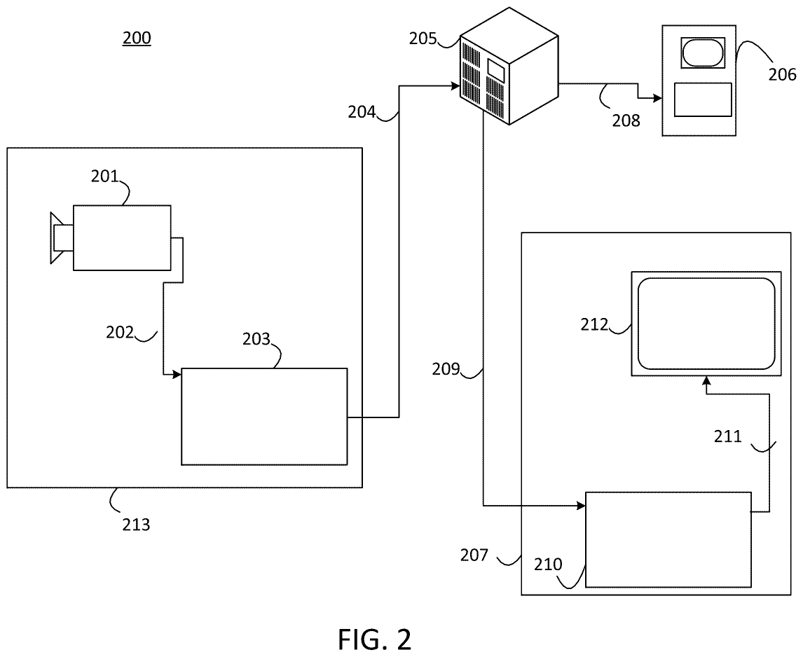

With reference to FIGS. 1-2, one or more embodiments of the present disclosure for implementing encoding and decoding structures of the present disclosure are described.

FIG. 1 illustrates a simplified block diagram of a communication system 100 according to an embodiment of the present disclosure. The system 100 may include at least two terminals 110, 120 interconnected via a network 150. For unidirectional transmission of data, a first terminal 110 may code video data, which may include mesh data, at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be, for example, servers, personal computers, and smart phones, and/or any other type of terminals. For example, the terminals (110-140) may be laptop computers, tablet computers, media players and/or dedicated video conferencing equipment. The network 150 represents any number of networks that convey coded video data among the terminals 110-140 including, for example, wireline and/or wireless communication networks. The communication network 150 may exchange data in circuit-switched and/or packet-switched channels. Representative networks include telecommunications networks, local area networks, wide area networks, and/or the Internet. For the purposes of the present discussion, the architecture and topology of the network 150 may be immaterial to the operation of the present disclosure unless explained herein below.

FIG. 2 illustrates, as an example of an application for the disclosed subject matter, a placement of a video encoder and decoder in a streaming environment. The disclosed subject matter may be used with other video enabled applications, including, for example, video conferencing, digital TV, storing of compressed video on digital media including CD, DVD, memory stick and the like, and so on.

As illustrated in FIG. 2, a streaming system 200 may include a capture subsystem 213 that includes a video source 201 and an encoder 203. The streaming system 200 may further include at least one streaming server 205 and/or at least one streaming client 206.

The video source 201 may create, for example, a stream 202 that includes a 3D mesh and metadata associated with the 3D mesh. The video source 201 may include, for example, 3D sensors (e.g. depth sensors) or 3D imaging technology (e.g. digital camera(s)), and a computing device that is configured to generate the 3D mesh using the data received from the 3D sensors or the 3D imaging technology. The sample stream 202, which may have a high data volume when compared to encoded video bitstreams, may be processed by the encoder 203 coupled to the video source 201. The encoder 203 may include hardware, software, or a combination thereof to enable or implement aspects of the disclosed subject matter as described in more detail below. The encoder 203 may also generate an encoded video bitstream 204. The encoded video bitstream 204, which may have a lower data volume when compared to the uncompressed stream 202, may be stored on a streaming server 205 for future use. One or more streaming clients 206 and 207 may access the streaming server 205 to retrieve video bit streams 208 and 209, respectively that may be copies of the encoded video bitstream 204.

The streaming clients 207 may include a video decoder 210 and a display 212. The video decoder 210 may, for example, decode video bitstream 209, which is an incoming copy of the encoded video bitstream 204, and create an outgoing video sample stream 211 that may be rendered on the display 212 or another rendering device (not depicted). In some streaming systems, the video bitstreams 204, 208, and 209 may be encoded according to certain video coding/compression standards.

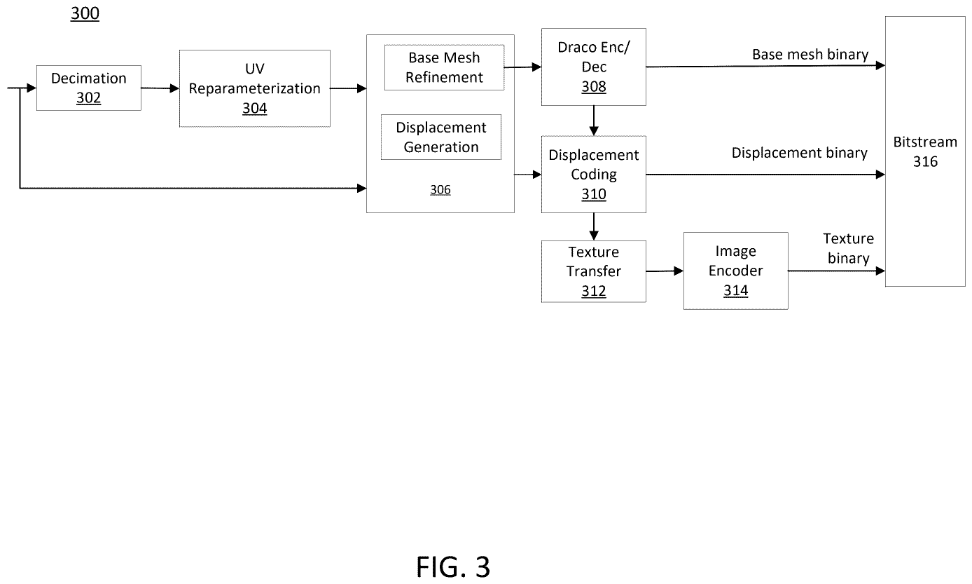

FIG. 3 illustrates an example mesh encoder 300. The encoder 300 may perform the V-DMC process for performing decimation and reparameterization before encoding a bitstream. As illustrated in FIG. 3, an input mesh may be subject to decimation 302 and UV reparameterization 304. Subsequently geometry reparameterization 306 is performed that includes base mesh refinement and displacement generation. The output of the base mesh refinement is provided to a Draco encoder 308 to generate a base mesh binary. The output of the displacement generation is provided to displacement coding 310 to generate displacement binary. The output of displacement coding 310 is provided to texture transfer 312 and image encoder 314 to generate texture binary. The base mesh binary, texture binary, and displacement binary may be included in bitstream 316. In one or more examples, texture coordinates or UV coordinates (often shortened to UVs) map the vertices to locations on the textures through a process called “UV Mapping”. The UVs define a 2D position in texture space for each vertex in the mesh.

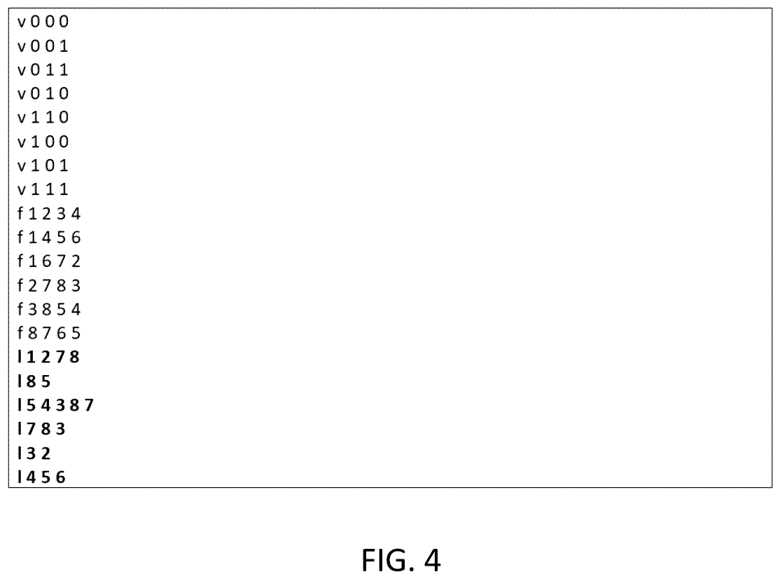

The embodiments are directed to prediction methods for the vertices in crease attributes. FIG. 4 provides an example of the crease/line attribute, where the three creases/lines are defined in the lines beginning with the letter “l”. The elements following the letter “l” represents the indices of the vertices, which start with the letter “v”. Specifically, the “1” after the letter “l” indicates the first vertex starting with “v” (i.e., 0 0 0), and the next number “2” signifies the second vertex starting with “V” (i.e., 0 0 1). In one or more examples, the crease attributes can be represented in many mesh formats, like USD, PLY, etc. The embodiments of the present disclosure may be provided to these formats.

The embodiments may describe the crease information by the sharpness and a set of indices that identify the edges to be creased. Each crease may be represented in a line that consists of a set of indices identifying the edge, and its sharpness is represented in another line that consists of sharpness numbers. The OBJ format may be provided as an example. The element “l” may be used to indicate the edge information in the crease and use an element “s” to indicate the sharpness of the crease. The numbers after “l” are the vertex indices identifying the edges that should be creased, and the numbers after “s” are the sharpness for each crease that should be applied to the edges identified by the line starting with “l”. The order of the lines starting with “l” corresponds to the order of the numbers in the lines starting with “s”. In one or more, the first line starting with “1” should be creased by the first number in the line starting with “s.”

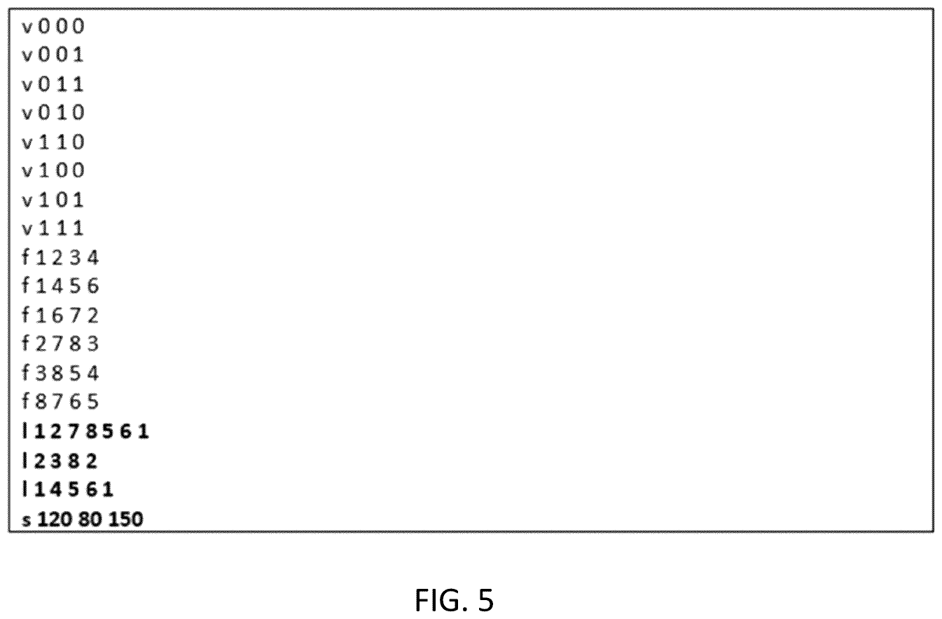

As shown in FIG. 5, the crease information is highlighted in bold. There are three creases in this OBJ file, where each crease occupies a line starting with the letter “l” and its corresponding sharpness is identified in the line starting with “s”. Specifically, the first crease is “l 1 2 7 8 5 6 1”, and its sharpness is the first number (i.e., 120) in the line starting with “s.”

In one or more examples, the format of the crease information may be the following:
l the_indices_of_vertices
l the_indices_of_vertices
. . .
s sharpness_1, sharpness_2, . . .
where the_indices_of_vertices is an array of integers to specify a set of vertex indices that form the crease, and sharpness_1 is the sharpness for the first “l the_indices_of_vertices”, and sharpness_2 is the sharpness for the second “l the_indices_of_vertices.”

The above representation may also be written as follows:
l idx_1 idx_2 . . . idx_n
l idx_1 idx_2 . . . idx_n
. . .
s sharpness_idx_1 sharpness_idx_2
where “idx_1 idx_2 . . . idx_n” is an array of integers to specify a set of vertex indices that form the crease, and sharpness_idx_1 is the sharpness for the first “l idx_1 idx_2 . . . idx_n”, and sharpness_idx_2 is the sharpness for the second “l idx_1 idx_2 . . . idx_n”.

In one or more examples, the line of the sharpness information may be separated into different lines as follows:
l idx_1 idx_2 . . . idx_n
l idx_1 idx_2 . . . idx_n
. . .
s sharpness_idx_1
s sharpness_idx_2
. . .

In one or more examples, the line of the crease information can start with other letters, and the line of the sharpness information can also start with other letters. In one or more examples, the line of the crease information can be anywhere in the file, and the line of the sharpness information can also be anywhere in the file. The line of the crease information does not need to be ahead of the line of the sharpness information. In one or more examples, the sharpness can be represented by a quantized number, or an integer, or a decimal number, or any mapping number.

Considering the geometric properties of the creases, the embodiments include an efficient method for crease attribute coding based on adjacent vertices. This method includes three parts, which are crease grouping, crease attribute coding, and vertex prediction for crease attribute coding.

The process may be divided into three parts: preprocessing, coding the number of vertex indices of each crease, and coding the vertex indices in each crease. In the following section, we explain the three parts step by step.

Since the crease attributes are composed of connected edges, the creases may be grouped to make the last vertex of a crease the same as the first vertex of the next crease. The purpose of this crease grouping is to connect as many creases as possible into a line, and this line does not have branches. Therefore, in one or more examples, only the initial vertex in the crease group needs to be signaled, in which the remaining vertices are predicted based on geometric connectivity. Preprocessing may include the following operations:
For all the creases, flip the crease if its first vertex is bigger than the last vertex.
Sort the creases in ascending order by the first vertex.
Find the first unused crease in the table. Mark this crease as used.
Take the last vertex of the found crease and find the unused crease in the table whose first vertex is the same as this vertex. Mark the found crease as used. If no unused creases can be found, find the unused crease whose last vertex is the same as this vertex. Flip this crease and mark the found crease as used. Repeat this step until no unused creases can be found. All the creases found in this step belong to a group.
Repeat the last 2 steps until all the creases are used.

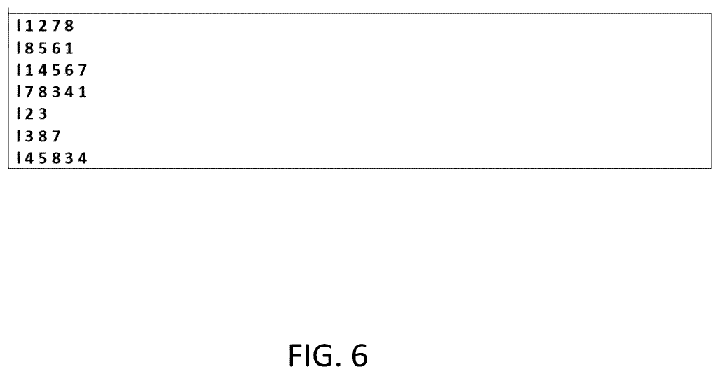

In one or more examples, since the crease attributes are usually connected, the crease may be reordered to let the last vertex of the current crease be the same as the first vertex of the next crease. The order of the vertex indices in a crease may also be flipped to make the last vertex of the crease the same as the first vertex of the next crease. For example, in FIG. 6, the crease attributes may be reordered, where all the creases are reordered and the original crease [3, 2] is flipped to [2, 3].

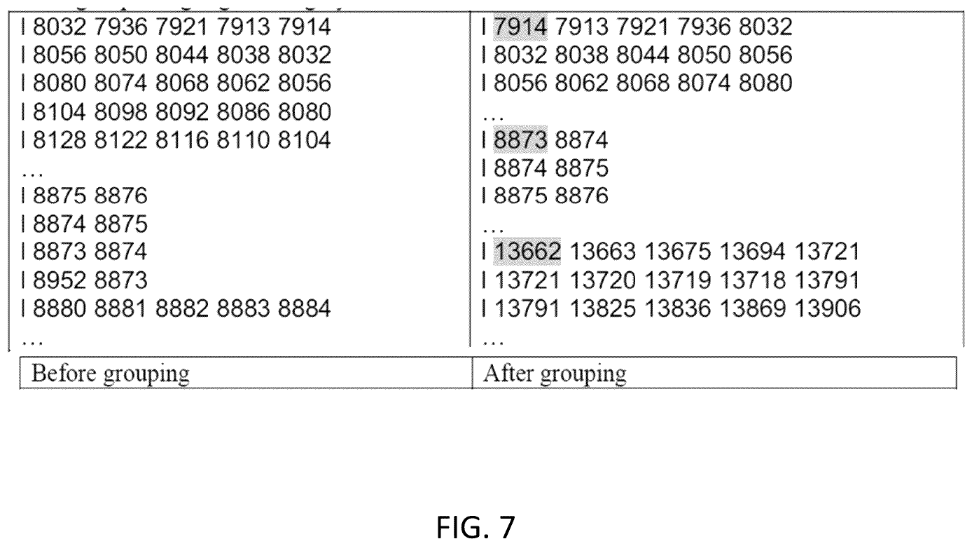

FIG. 7 illustrates an example of the crease attributes before and after grouping. The initial vertex in each crease group is highlighted in grey.

After grouping the creases into crease groups, two parts of the crease attributes may be coded. These two attributes may include (i) number of vertices in each crease; and (ii) vertices in each crease.

This method may encode the number of creases, the number of vertices in all creases, and/or the minimum number of vertices in all creases. For each crease, the method may encode the number of vertices within the crease minus the minimum number of vertices in all creases, and encode if this crease is the initial crease (e.g., the first crease) in the crease group. In one or more examples, the number of vertices for the last crease may not be signaled as this parameter may be derived from the total number of vertices of all creases minus the sum of the number of vertices from the first crease to the second-to-last crease.

For each vertex in the creases, if the vertex being coded is the initial vertex in a crease group (e.g., the first vertex in the initial crease in a crease group), the first vertex of the previous crease group may be used as a predictor and encode the prediction residue. If the vertex being coded is not the initial vertex in a crease group but is the first vertex in a crease (e.g., the first vertex in the non-initial crease), the vertex does not need to be encoded, but instead, may be derived by duplicating the last vertex in the previous crease. If the vertex being coded is not the initial vertex in a crease group nor the first vertex in a crease, the predictors of this vertex may be computed. The connected vertices of the previous vertex may be used to predict the current vertex, and “−1” may be used as a predictor index to indicate that the current vertex is not connected to the previously encoded vertex. The predictor index may be enocded, and if the predictor index is smaller than 0, we encode the residue of the prediction value to the index value of the vertex being encoded.

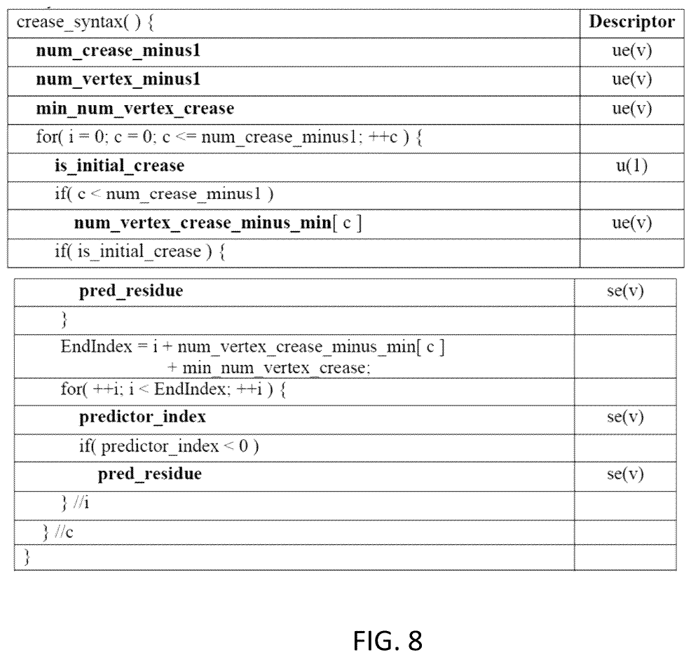

Example syntax and semantics are illustrated in FIG. 8.

num_crease_minus1: specifies the total number of creases minus 1.

num_vertex_minus1 specifies the total number of vertices in all the creases minus 1.

min_num_vertex_crease specifies the minimum number of vertices of all the creases. For example, in FIG. 8, min_num_vertex_crease is 2.

num_vertex_crease_minus_min[c] specifies the number of vertices minus (min_num_vertex_crease) in the cth crease. For example, in FIG. 8, num_vertex_crease_minus_min[0] is 3.

is_initial_crease specifies if the c^{th} crease is the first crease in a crease group. It is “1” (or “true”) if the c^{th} crease is the first crease in a crease group, and it is “0” (or “false”) if the c^{th} crease is not the first crease in a crease group. For example, in FIG. 8, the is_initial_crease of the first crease is 1, and the is_initial_crease of the second crease is 0.

predictor_index specifies the predictor index of one of the predictors used to predict the vertex in the crease. If it is “−1”, it indicates that no predictors result in zero residue.

pred_residue specifies the residue of the prediction value of predictor_index to the vertex in the crease.

The embodiments are directed to methods for efficiently predicting the vertices in crease attributes. Note that the proposed methods can also be applied to line attributes. Since the indices of the vertices are used to represent the vertices in the crease. Thus, the indices of the vertices (e.g., [1 2 7 8 8 5 5 4 3 8 7 7 8 3 3 2 4 5 6]) may be encoded rather than the positions of the vertices for the crease attributes. Since crease attributes are composed of multiple successive edges, the geometry connectivity of the vertex may be used to predict the index of the next vertex in the crease.

In one or more examples, all the numbers of vertices of each crease may be concatenated as a 1D array Array_{#vertices}_{_{creases}}. As shown in eq1, where #vertices_{crease}_{ₙ} indicates the number of vertices in the n-th crease, and N indicates the total number of creases.

$$Eq . ( 1 )$$

$${Array}_{\# {vertices}_{creases}} = [ {\#vertices}_{{crease}_{0}} , {\#vertices}_{{crease}_{1}} , {\#vertices}_{{crease}_{N - 1}} ]$$

For example, in FIG. 6, the Array_{#vertices}_{_{creases}}=[4, 4, 5, 5, 2, 3, 5], and N=7.

In one or more examples, the numbers in the Array_{#vertices}_{_{creases}} may be directly encoded.

In one or more examples, the minimum number min_{#vertices} in the array may be found, as in Eq. (2), and the array with this minimum number may be subtracted, as in Eq. (3). Then, the numbers in the array and the minimum number may be encoded.

$$Eq . ( 2 )$$

$${min}_{\# vertices} = MIN ( {\#vertices}_{crease 0} , {\#vertices}_{crease 1} , … , {\#vertices}_{{crease}_{N - 1}} )$$

$$Eq . ( 3 )$$

$${Array}_{\# {vertices}_{creases}} = [ {\#vertices}_{{crease}_{0}} - {min}_{\# vertices} , {\#vertices}_{{crease}_{1}} - {min}_{\# verties} , … , {\#vertices}_{{crease}_{N - 1}} - {min}_{\# vertices} ]$$

For example, in FIG. 6, the min_{#vertices}=2, and Array_{#vertices}_{_{creases}}=[2, 2, 3, 3, 0, 1, 3].

In one or more embodiments, encoding the number of vertices of the last crease #vertices_{crease}_{_{N-1}} is skipped. Since after the number of vertices of the first N−2 creases are encoded, the number of vertices of the last crease #vertices_{crease}_{_{N-1}} may be derived from the total number of vertices in all the creases minus the summation of the previously encoded N−2 creases. These features are shown in Eq. (4). In this case, the total number of vertices in all creases may be encoded.

$${\#vertices}_{{crease}_{N - 1}} = {\#vertices}_{{crease}_{Total}} - {\sum }_{n = 0}^{n = N - 2} {\#vertices}_{{crease}_{n}} , \qquad Eq . ( 4 )$$

where #vertices_{crease}_{_{Total l is the total number of vertices in all the creases.}}

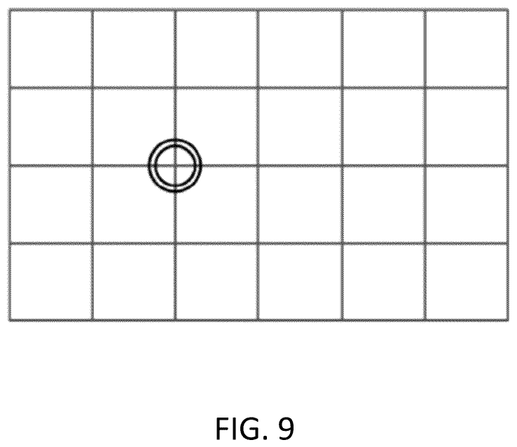

In one or more examples, for the initial vertex in the crease group, a predictor may be used as illustrated in FIG. 9. The first vertex in the previous crease group may be used.

In one or more examples, for the first vertex in the crease, “0” may be used as a predictor and the residue between the predicted vertex index and the vertex index being encoded may be encoded. In one or more embodiments, half of the total vertex number may be used as a predictor and encode the residue between the predicted vertex index and the vertex index being encoded.

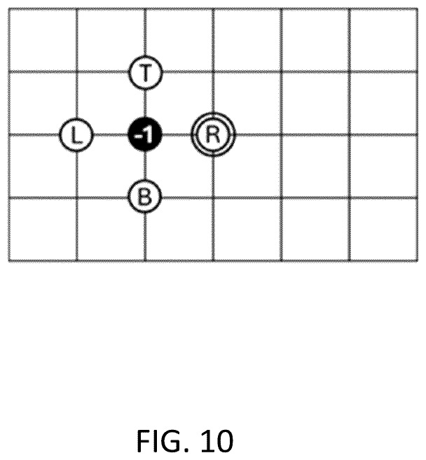

In FIG. 10, the index of the white vertex R with the double circle is being encoded. The black vertex marked “−1” indicates the previous vertex that is encoded. The indices of the white vertices marked “R”, “T”, “L”, and “B” are the predictors for the index of the vertex to be encoded (e.g., white vertex R with the double circle). As illustrated in FIG. 10, multiple predictors may be used, where all the connected vertices of the previous vertex (−1) are predictors.

In one or more examples, after the first vertex index is encoded, the connected vertices' indices of the previous encoded vertex may be used as predictors to predict the next vertex index. For example, when we are encoding an index of a vertex after the first vertex index is encoded, the connected vertices' indices of its previous encoded vertex may be used as predictors to predict the index of the vertex we are encoding. As the example shown in FIG. 10, the vertex index being encoded is the white vertex R with the double circle; the connected vertices' indices of the previous encoded vertex “−1” may be used as predictors to predict the white vertex R's index.

Therefore, the predictors to predict the index of the vertex R may be:

$${Predictors}_{{Index}_{vertexR}} = \{ \begin{matrix}Predictor 0 = {Index}_{vertexT} \\ Predictor 1 = {Index}_{vertexR} \\ Predictor 2 = {Index}_{vertexB} \\ Predictor 3 = {Index}_{vertexL}\end{matrix} \qquad Eq . ( 5 )$$

In one or more examples, the number of connected vertices (e.g., the number of predictors) may be any number. In one or more examples, this operation is repeated until all the vertex indices in the crease are encoded.

In one or more examples, at the encoder side, the predictors may be computed by using the connected vertices of the previously encoded vertex. Each predictor has an index. For each predictor, the total bits that would be spent on the coding of the predictor index and its residue to the vertex index being encoded may be estimated. The predictor that produces the least total bits for coding its index and the residue may be chosen, and its predictor index and prediction residue in the bitstream may be encoded. At the decoder side, the predictors may be derived using the connected vertices of the previously decoded vertex. Then the predictor index may be decoded to get the predictor and decode the corresponding residue, and added back to the predicted vertex index from the predictor to reconstruct the original encoded vertex index. Since the smaller predictor index needs fewer bits, in one or more examples, the more accurate predictor may be given a smaller index number. Using Eq. (5) as an example, the predictor indices are the numbers from 0 to 3. In one or more examples, the more accurate predictor may be given a smaller index number (e.g., 0), and the less accurate predictor may be given a bigger index number (e.g., 3) to save the bits in the bitstream.

In one or more examples, at the encoder side, each predictor has an ID. For each predictor, we estimate the total bits that would be spent on the coding of the predictor ID and its residue to the index being encoded. We choose the predictor that produces the least total bits for coding its ID and the residue, and encode its ID and residue in the bitstream. At the decoder side, we derive the predictors using the connected vertices of the last decoded vertex. Then decode the predictor ID to get the right predictor and decode the corresponding residue, and add it back to the predicted index from the predictor to reconstruct the original encoded vertex index. Since the smaller predictor ID needs fewer bits, it is better to give the more accurate predictor a smaller ID number. We take eq5 as an example, the predictor IDs are the numbers from 0 to 3. It is better to give the more accurate predictor a smaller ID number (e.g., 0), and give the less accurate predictor a bigger ID number (e.g., 3) to save the bits in the bitstream.

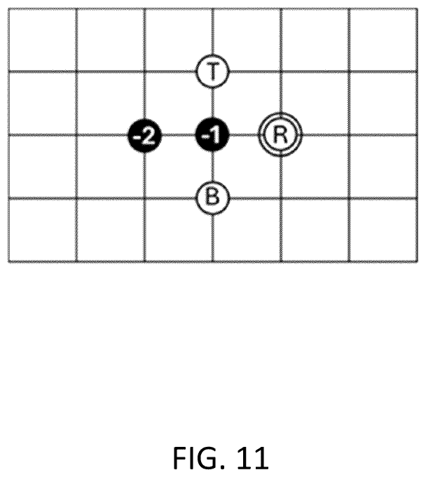

In FIG. 11, the index of the white vertex R with the double circle is being encoded. The black vertex marked “−1” indicates the last vertex index that is encoded. The black vertex marked “−2” indicates the second-to-last vertex index that is encoded. The indices of the white vertices marked “R”, “T”, and “B” are the predictors for the index of the vertex to be encoded (i.e., white vertex R with the double circle).

As illustrated in FIG. 11, multiple predictors may be used. All the connected vertices of the previous vertex (−1) may be predictors. Priority +1 may be used if the vertex is not in the same face with the previous vertex (−2). Priority −1 may be used if the vertex is the previous vertex (−2).

In one or more examples, after the second vertex is encoded, the information from previously encoded indices may be used to give better predictor indices for the predictors.

Criterion 1: Since the next vertex in a crease is usually in the opposite direction of the second-to-last encoded vertex, the connected vertex that is in the opposite direction of the second-to-last vertex may be found and given a smaller or the smallest predictor index.

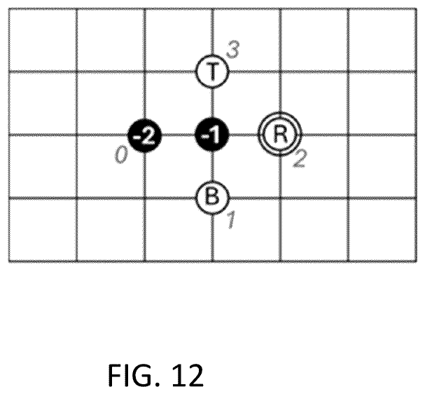

For example, in FIG. 12, when encoding the index of vertex R, the connected vertices' indices of the last encoded vertex −1 may be used as predictors. Since the vertex in a crease is usually in the opposite direction of the second-to-last encoded vertex −2, the predictor that is the index of vertex R may be given the smallest index. In FIG. 12, the numbers in grey may be used to find the vertex in the opposite direction of the second-to-last encoded vertex.

In one or more examples, the following operations may be used to find the connected vertex that is in the opposite direction of the second-to-last vertex:

Operation 1: Give a number n to each connected vertex of the last encoded vertex in the counterclockwise direction.

Operation 2: Find the number nᵥ_{₋₂} of the second-to-last vertex given by Operation 1.

Operation 3: Find the number nᵥ_{ₒₚₚₒₛᵢₜₑ} of the connected vertex that is in the opposite direction by:

### Eq. (6):

$${n}_{{v}_{opposite}} = modulus ( {n}_{{v}_{- 2}} - \frac{N}{2} , N ) ,$$

where N is the total number of connected vertices.

As shown in FIG. 12, the number n from 0 to N−1 is given to each connected vertex of the last encoded vertex in the counterclockwise direction (as the grey numbers in the figure). The number nᵥ_{₋₂} of the second-to-last vertex is nᵥ_{₋₂}=0. The number nᵥ_{ₒₚₚₒₛᵢₜₑ} of the connected vertex that is in the opposite direction may be:

$${n}_{{v}_{opposite}} = modulus ( {n}_{{v}_{- 2}} - \frac{N}{2} , N ) = modulus ( 0 - \frac{4}{2} , 4 ) = 2 \qquad Eq . ( 7 )$$

Criterion 2: Since a vertex in a crease is usually not in the same face as the second-to-last vertex, the connected vertices that are not in the same face as the second-to-last vertex are given smaller predictor indices and the connected vertices that are in the same face as the second-to-last vertex are given bigger predictor indices.

Criterion 3: Since a vertex in a crease is usually not the same as the second-to-last vertex, we give the connected vertex that is the same as the second-to-last vertex a bigger or the biggest predictor index.

For example, in FIG. 12, the white vertex R is given the smallest predictor index since it is in the opposite direction of the second-to-last encoded vertex −2. The white vertices “1” and “3” are given the bigger predictor indices since they are in the same face as the second-to-last encoded vertex −2. The black vertex −2 may be given the biggest predictor index since it is the same as the second-to-last encoded vertex −2. The predictors are shown as follows:

$${Predictors}_{{Index}_{{v}_{R}}} = \{ \begin{matrix}Predictor 0 = {Index}_{{v}_{R}} \\ Predictor 1 = {Index}_{{v}_{T}} \\ Predictor 2 = {Index}_{{v}_{B}} \\ Predictor 3 = {Index}_{{v}_{- 2}}\end{matrix} \qquad Eq . ( 8 )$$

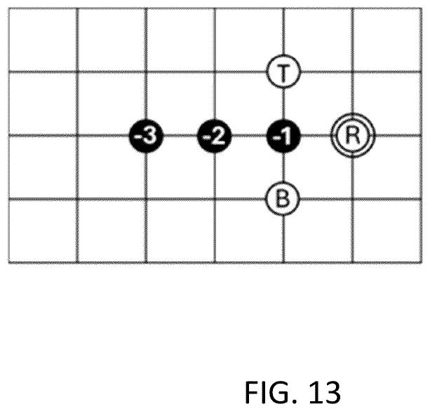

In FIG. 13, the index of the white vertex R with the double circle is being encoded. The black vertex marked “−1” indicates the last vertex index that is encoded. The black vertex marked “−2” indicates the second-to-last vertex index that is encoded. The black vertex marked “−3” indicates the third-to-last vertex index that is encoded. The indices of the white vertices marked “R”, “T”, and “B” are the predictors for the index of the vertex to be encoded (e.g., white vertex R with the double circle).

As illustrated in FIG. 13, multiple predictors may be used. All the connected vertices of the previous vertex (−1) may be predictors. Priority +1 may be used if the vertex is not in the same face with the previous vertex (−2). Priority −1 may be used if the vertex is the previous vertex (−2). Priority +1 may be used if the vertex has a similar angle to the previous angle (e.g., the angle between vertex −1, −2, −3).

After the third index is encoded, the information from previously encoded indices may be used to give better predictor indices for the predictors.

Criterion 4: Since the angles between every successive 3 vertices in a crease are usually the same, the angle between the last three encoded vertices Angleₗₐₛₜ (Angle₋₁₋₂₋₃ in FIG. 13) may be computed and the angle between the last two encoded vertices and each of the predictor vertices (Angle_{-2-1T}, Angle_{-2-1R}, Angle_{-2-1B} in FIG. 13, respectively) may be computed, and the vertex with the same angle as Angle₋₁₋₂₋₃ may be given a smaller or the smallest predictor index. In the example shown in FIG. 13, the white vertex R may be given the smallest predictor index. This step may be repeated until all the indices in the array are encoded. Note that the angles between every successive 3 vertices in a crease do not need to be exactly the same. A range r, and the vertex with the angle within the range Angleₗₐₛₜ±r, may be given a smaller or the smallest predictor index. This range r may be 1, or 2, or any number.

Note that after the third index is encoded, the prediction scheme used after the second index is encoded may be applied. In one or more examples, after all the vertex indices in the first crease are encoded, the last vertex index may be used as a predictor to predict the first vertex index of the next crease. Since the creases are re-ordered, the last vertex in a crease is usually the first vertex of the next crease. For example, when coding the first vertex in a crease, we can use the last vertex in the last crease as one of the predictors.

Criterion 5: When coding the first vertex in a crease, the last vertex may be used in the previous crease as one of the predictors and the predictor may be given a smaller or the smallest predictor index. For example, in FIG. 4, when encoding the first vertex index “8” of the second crease, the last vertex index “8” in the last crease may be used as one of the predictors and may be given a smaller or the smallest predictor index.

In one or more examples, when coding the last vertex in a crease, the encoded first vertex in the crease may be used as one of the predictors since the creases are usually closed loops.

Criterion 6: A crease is sometimes a closed loop. Hence, when coding the last vertex in a crease, the encoded first vertex in the crease may be used as one of the predictors and this predictor may be given a smaller or the smallest predictor index. Overall, the prediction methods and the criteria for assigning the predictor indices mentioned above can be applied individually or in any combination and with any priority.

In one or more examples, every criterion gives a score. If a predictor meets the criterion, a score may be added to the predictor. After checking all the criteria, the scores of each predictor may be summed up and ranked from the highest to the lowest. The predictor with the highest score receives the smallest predictor index. The predictor with the second-highest score receives the second-smallest predictor index, and so on. Note that the score given in a criterion can be any number, and the score given in each criterion can be the same or different.

In one or more examples, the priority scores given by each criterion may be summed up and the predictor with the highest score may be given the smallest predictor index, and the predictor with the second highest score may be given the second smallest predictor index, and so on.

In one or more examples, any number of predictors may be used. If there is a specific number N_{predictors} of predictors designed in the encoder and decoder, the first N_{predictors} may be selected ranking by the predictor indices (from smallest to the biggest) assigned by the criteria mentioned above.

In one or more examples, all the vertex indices in the creases are concatenated into a 1D array. The coding operations mentioned above may be repeated until all the indices are coded.

In one or more examples, each crease may be treated individually. The coding operations mentioned above may be repeated for each crease until all the creases are coded.

In one or more examples, a quad mesh may be used as an example. The embodiments of the present disclosure may be used in a triangular mesh or any polygonal mesh.

The embodiments may be implemented as a vertex-based attribute indices coding strategy in the software. SparseAttributeCreaseIndicesEncoder/Decoder and SparseAttributeCreaseIndicesPredictor may be added for the crease attribute coding. For the original sparse attribute coding, SparseAttributeIndicesEncoder/Decoder and SparseAttributeLinearPredictor may be added in other attribute indices coding strategies.

For sparse attribute crease indices coding, the input to this process may be a bitstream of the crease attributes. The output of this process may be an array of the numbers of vertices in each crease (e.g., num_vertex_crease_minus_min[c]+min_num_vertex_crease) and an array of the vertices in all creases (e.g., index_vertex_crease[i]).

The decoding process may first decode the number of creases minus one (e.g., num_crease_minus1), the number of vertices in all creases minus one (e.g., num_vertex minus1), and the minimum number of vertices in all creases (e.g., min_num_vertex_crease).

For each crease, if the crease is not the last crease, it decodes the number of vertices of the crease minus the minimum number of vertices of all creases (i.e., num_vertex_crease_minus_min[c]).

If the crease is the last crease, the number of vertices of the crease minus the minimum number of vertices of all creases may be derived by the total number of vertices in all creases minus the sum of the number of vertices of all previous creases minus the minimum number of vertices in all creases.

For decoding the first vertex in the crease, it decodes if the crease is the initial crease (e.g., is_initial_crease). If yes, it decodes the prediction residue (i.e., pred_residue) and derives the index of the first vertex (e.g., index_vertex_crease[i]) in this crease by adding the residue to the index of the first vertex in the previous crease group (i.e., PrevInitVertex). It updates the previous initial vertex (e.g., PrevInitVertex) with this derived vertex index. If no, which means the crease is not the initial crease, it derives the index of the first vertex (e.g., index_vertex_crease[i]) in this crease by using the index of the last vertex (e.g., LastVertex). Then, it updates the index of the last vertex with the derived vertex index.

To decode the remaining vertices in the crease, specifically from the second to the last vertex, it computes the predictors and decodes the predictor index (e.g., predictor_index). If the predictor index is bigger than or equal to zero, the index of the vertex is equal to the prediction of the predictor index. If the predictor index is smaller than zero, it means that no predictions have zero residual results. It decodes the prediction residue (e.g., pred_residue) and adds it to the index of the last vertex to derive the index of the vertex.

In the compute the predictor set for the sparse attribute crease indices predictor, this process generates a set of predictors that predict the value of a vertex in the crease attribute.

The number of predictions depends on the number of adjacent vertices (e.g., Adj VerticesCount). The variable vertex0 refers to the last vertex, vertex1 refers to the second-to-last vertex, vertex2 refers to the third-to-last vertex. The variable pos0 refers to the position of vertex0, pos1 refers to the position of vertex1, the variable pos2 refers to the position of vertex2, and the variable pos refers to the position of the current vertex.

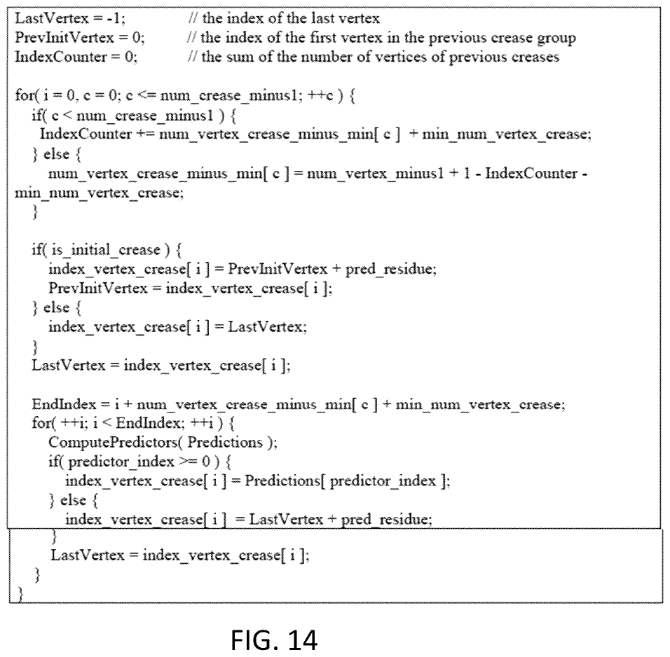

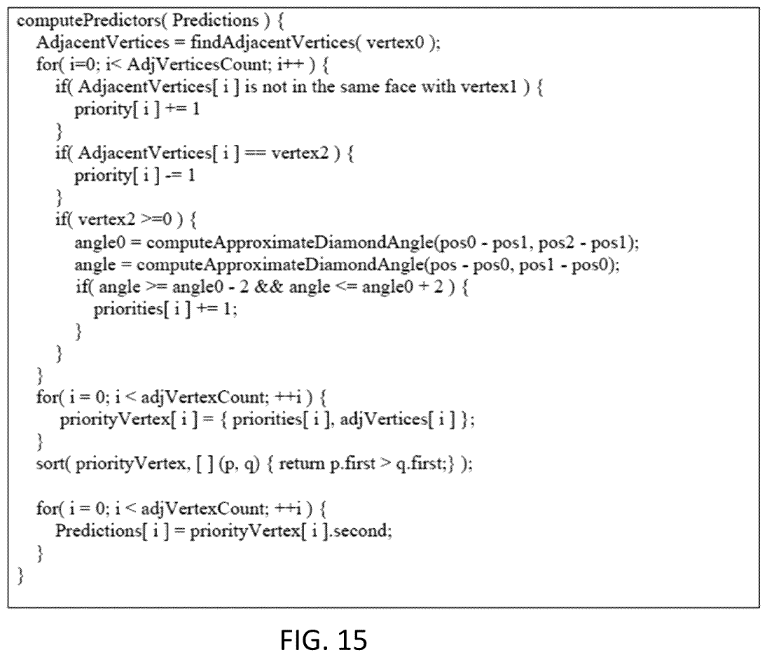

FIGS. 14 and 15 illustrate example processes for computing predictors.

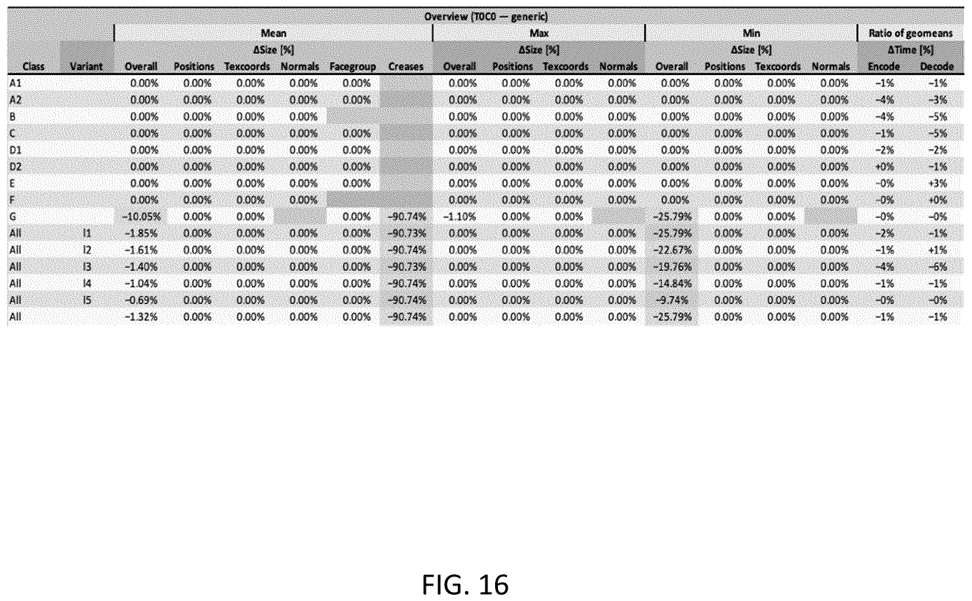

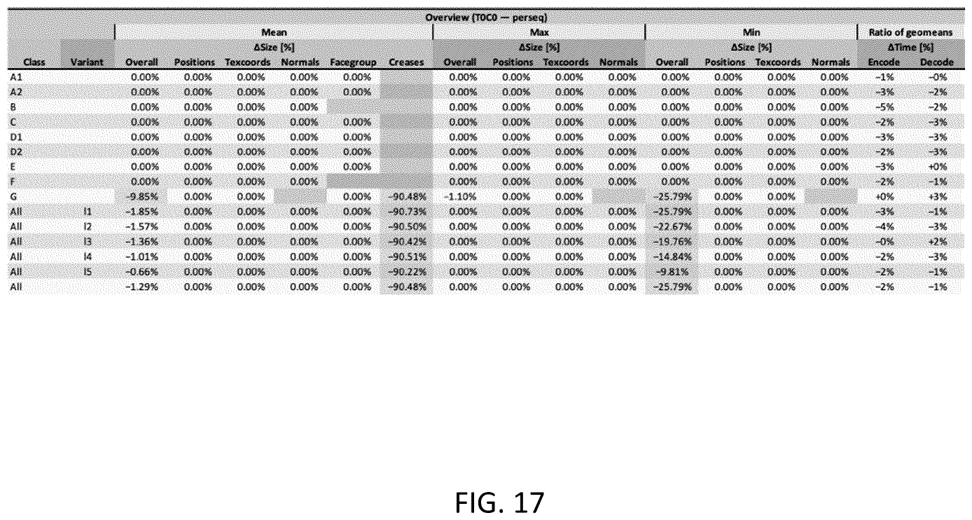

The proposed embodiments provide a coding gain of 90.74% for the crease attribute and 10.05% for the total bitstream in the generic configuration. The embodiments yield a coding gain of 90.48% for the crease attribute and 9.85% for the total bitstream in the per-sequence configuration. With the proposed method, the percentage of the crease attribute in the total bitstream decreases from 11% to 1.1%. FIGS. 16 and 17 illustrate example results.

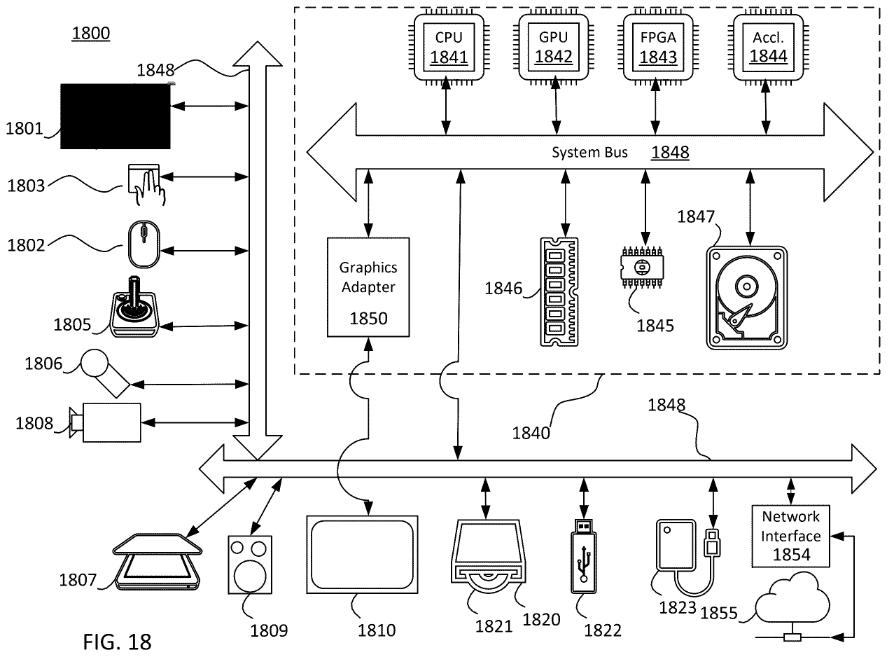

The techniques, described above, may be implemented as computer software using computer-readable instructions and physically stored in one or more computer-readable media. For example, FIG. 18 shows a computer system 1800 suitable for implementing certain embodiments of the disclosure.

The computer software may be coded using any suitable machine code or computer language, that may be subject to assembly, compilation, linking, or like mechanisms to create code including instructions that may be executed directly, or through interpretation, micro-code execution, and the like, by computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 18 for computer system 1800 are examples and are not intended to suggest any limitation as to the scope of use or functionality of the computer software implementing embodiments of the present disclosure. Neither should the configuration of components be interpreted as having any dependency or requirement relating to any one or combination of components illustrated in the non-limiting embodiment of a computer system 1800.

Computer system 1800 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 1801, mouse 1802, trackpad 1803, touch screen 1810, data-glove, joystick 1805, microphone 1806, scanner 1807, camera 1808.

Computer system 1800 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 1810, data glove, or joystick 1805, but there may also be tactile feedback devices that do not serve as input devices). For example, such devices may be audio output devices (such as: speakers 1809, headphones (not depicted)), visual output devices (such as screens 1810 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system 1800 may also include human accessible storage devices and their associated media such as optical media including CD/DVD ROM/RW 1820 with CD/DVD or the like media 1821, thumb-drive 1822, removable hard drive or solid state drive 1823, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 1800 may also include interface to one or more communication networks. Networks may be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 1849 (such as, for example USB ports of the computer system 1800; others are commonly integrated into the core of the computer system 1800 by attachment to a system bus as described below (for example Ethernet interface into a PC computer system or cellular network interface into a smartphone computer system). Using any of these networks, computer system 1800 may communicate with other entities. Such communication may be uni-directional, receive only (for example, broadcast TV), uni-directional send-only (for example CANbus to certain CANbus devices), or bi-directional, for example to other computer systems using local or wide area digital networks. Such communication may include communication to a cloud computing environment 1855. Certain protocols and protocol stacks may be used on each of those networks and network interfaces as described above.

Aforementioned human interface devices, human-accessible storage devices, and network interfaces 1854 may be attached to a core 1840 of the computer system 1800.

The core 1840 may include one or more Central Processing Units (CPU) 1841, Graphics Processing Units (GPU) 1842, specialized programmable processing units in the form of Field Programmable Gate Areas (FPGA) 1843, hardware accelerators for certain tasks 1844, and so forth. These devices, along with Read-only memory (ROM) 1845, Random-access memory 1846, internal mass storage such as internal non-user accessible hard drives, SSDs, and the like 1847, may be connected through a system bus 1848. In some computer systems, the system bus 1848 may be accessible in the form of one or more physical plugs to enable extensions by additional CPUs, GPU, and the like. The peripheral devices may be attached either directly to the core's system bus 1848, or through a peripheral bus 1849. Architectures for a peripheral bus include PCI, USB, and the like. A graphics adapter 1850 may be included in the core 1840.

CPUs 1841, GPUs 1842, FPGAs 1843, and accelerators 1844 may execute certain instructions that, in combination, may make up the aforementioned computer code. That computer code may be stored in ROM 1845 or RAM 1846. Transitional data may be also be stored in RAM 1846, whereas permanent data may be stored for example, in the internal mass storage 1847. Fast storage and retrieve to any of the memory devices may be enabled through the use of cache memory, that may be closely associated with one or more CPU 1841, GPU 1842, mass storage 1847, ROM 1845, RAM 1846, and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture 1800, and specifically the core 1840 may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core 1840 that are of non-transitory nature, such as core-internal mass storage 1847 or ROM 1845. The software implementing various embodiments of the present disclosure may be stored in such devices and executed by core 1840. A computer-readable medium may include one or more memory devices or chips, according to particular needs. The software may cause the core 1840 and specifically the processors therein (including CPU, GPU, FPGA, and the like) to execute particular processes or particular parts of particular processes described herein, including defining data structures stored in RAM 1846 and modifying such data structures according to the processes defined by the software. In addition or as an alternative, the computer system may provide functionality as a result of logic hardwired or otherwise embodied in a circuit (for example: accelerator 1844), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof. The above disclosure also encompasses the embodiments listed below:

(1) An encoding method performed by at least one processor, the method including: receiving a polygon mesh comprising at least one crease; determining one or more predictors to predict a vertex of the at least one crease, each predictor corresponding to a vertex connected to a last previously encoded vertex in the at least one crease; and generating a bitstream comprising the polygon mesh and the one or more predictors.

(2) The method according to feature (1), in which a first predictor from the one or more predictors having a higher accuracy than a second predictor from the one or more predictors is encoded with a smaller index than the second predictor.

(3) The method according to feature (1) or (2), in which the determining the one or more predictors further comprises applying one or more criteria to the one or more predictors and a second-to-last previously encoded vertex in the at least one crease.

(4) The method according to feature (3), in which the one or more criteria specifies that a vertex opposite to the second-to-last previously encoded vertex with a smallest index.

(5) The method according to feature (3) or (4), in which the one more criteria specifies that a vertex not in a same face as the second-to-last vertex is encoded with a smaller index than a vertex that is in the same face as the second-to-last vertex.

(6) The method according to any one of features (3)-(5) in which the one or more criteria specifies that the second-to-last vertex is encoded with an index bigger than another vertex that is not the second-to-last vertex.

(7) The method according to any one of features (3)-(6) in which the one or more criteria specifies that a vertex having an angle within a predetermined range is encoded with a smaller index than a vertex having an angle outside of the predetermined range.

(8) The method according to any one of features (3)-(7) in which the one or more criteria specifies that when coding a first vertex in the at least one crease, a last vertex in a previous crease is a predictor.

(9) The method according to any one of features (3)-(8) in which the one or more criteria specify that when encoding a last vertex in the at least one crease, a first vertex in the crease is a predictor.

(10) The method according to any one of features (3)-(9), in which each predictor that meets a criteria is a assigned a score, and in which a first predictor with a higher score than a second predictor is encoded with a smaller index than the second predictor.

(11) A decoding method performed by at least one processor, the method including: receiving a bitstream comprising a polygon mesh and one or more predictors; for predicting a vertex in at least one crease; polygon mesh comprising at least one crease; decoding a first vertex in at least one crease in the polygon mesh; decoding the one or more predictors based on connected vertices of the first vertex; and determining a residue based on the one or more predictors; reconstructing a second vertex in the at least one crease by adding the residue to the first vertex.

(12) The method according to feature (11), in which a first predictor from the one or more predictors having a higher accuracy than a second predictor from the one or more predictors is encoded with a smaller index than the second predictor.

(13) The method according to feature (11) or (12), in which the one or more predictors are encoded by applying one or more criteria to the one or more predictors and a second-to-last previously encoded vertex in the at least one crease.

(14) The method according to feature (13), in which the one or more criteria specifies that a vertex opposite to the second-to-last previously encoded vertex with a smallest index.

(15) The method according to feature (13) or (14), in which the one more criteria specifies that a vertex not in a same face as the second-to-last vertex is encoded with a smaller index than a vertex that is in the same face as the second-to-last vertex.

(16) The method according to any one of features (13)-(15), in which the one or more criteria specifies that the second-to-last vertex is encoded with an index bigger than another vertex that is not the second-to-last vertex.

(17) The method according to any one of features (13)-(16), in which the one or more criteria specifies that a vertex having an angle within a predetermined range is encoded with a smaller index than a vertex having an angle outside of the predetermined range.

(18) The method according to any one of features (13)-(17) in which the one or more criteria specifies that when coding a first vertex in the at least one crease, a last vertex in a previous crease is a predictor.

(19) The method according to any one of features (13)-(18), in which the one or more criteria specify that when encoding a last vertex in the at least one crease, a first vertex in the crease is a predictor.

(20) A non-transitory computer readable medium storing a bitstream that is generated by an encoding method, the encoding method including: receiving a polygon mesh comprising at least one crease; determining one or more predictors to predict a vertex of the at least one crease, each predictor corresponding to a vertex connected to a last previously encoded vertex in the at least one crease; and generating the bitstream comprising the polygon mesh and the one or more predictors.

What is claimed is:

1. An encoding method performed by at least one processor, the method comprising:
receiving a polygon mesh comprising at least one crease;
determining one or more predictors to predict a vertex of the at least one crease, each predictor corresponding to a vertex connected to a last previously encoded vertex in the at least one crease; and
generating a bitstream comprising the polygon mesh and the one or more predictors.

2. The method according to claim 1, wherein a first predictor from the one or more predictors having a higher accuracy than a second predictor from the one or more predictors is encoded with a smaller index than the second predictor.

3. The method according to claim 1, wherein the determining the one or more predictors further comprises applying one or more criteria to the one or more predictors and a second-to-last previously encoded vertex in the at least one crease.

4. The method according to claim 3, wherein the one or more criteria specifies that a vertex opposite to the second-to-last previously encoded vertex with a smallest index.

5. The method according to claim 3, wherein the one more criteria specifies that a vertex not in a same face as the second-to-last vertex is encoded with a smaller index than a vertex that is in the same face as the second-to-last vertex.

6. The method according to claim 3, wherein the one or more criteria specifies that the second-to-last vertex is encoded with an index bigger than another vertex that is not the second-to-last vertex.

7. The method according to claim 3, wherein the one or more criteria specifies that a vertex having an angle within a predetermined range is encoded with a smaller index than a vertex having an angle outside of the predetermined range.

8. The method according to claim 3, wherein the one or more criteria specifies that when coding a first vertex in the at least one crease, a last vertex in a previous crease is a predictor.

9. The method according to claim 3, wherein the one or more criteria specify that when encoding a last vertex in the at least one crease, a first vertex in the crease is a predictor.

10. The method according to claim 3, wherein each predictor that meets a criteria is a assigned a score, and wherein a first predictor with a higher score than a second predictor is encoded with a smaller index than the second predictor.

11. A decoding method performed by at least one processor, the method comprising:
receiving a bitstream comprising a polygon mesh and one or more predictors; for predicting a vertex in at least one crease; polygon mesh comprising at least one crease;
decoding a first vertex in at least one crease in the polygon mesh;
decoding the one or more predictors based on connected vertices of the first vertex;
determining a residue based on the one or more predictors; and
reconstructing a second vertex in the at least one crease by adding the residue to the first vertex.

12. The method according to claim 11, wherein a first predictor from the one or more predictors having a higher accuracy than a second predictor from the one or more predictors is encoded with a smaller index than the second predictor.

13. The method according to claim 11, wherein the one or more predictors are encoded by applying one or more criteria to the one or more predictors and a second-to-last previously encoded vertex in the at least one crease.

14. The method according to claim 13, wherein the one or more criteria specifies that a vertex opposite to the second-to-last previously encoded vertex with a smallest index.

15. The method according to claim 13, wherein the one more criteria specifies that a vertex not in a same face as the second-to-last vertex is encoded with a smaller index than a vertex that is in the same face as the second-to-last vertex.

16. The method according to claim 13, wherein the one or more criteria specifies that the second-to-last vertex is encoded with an index bigger than another vertex that is not the second-to-last vertex.

17. The method according to claim 13, wherein the one or more criteria specifies that a vertex having an angle within a predetermined range is encoded with a smaller index than a vertex having an angle outside of the predetermined range.

18. The method according to claim 13, wherein the one or more criteria specifies that when coding a first vertex in the at least one crease, a last vertex in a previous crease is a predictor.

19. The method according to claim 13, wherein the one or more criteria specify that when encoding a last vertex in the at least one crease, a first vertex in the crease is a predictor.

20. A non-transitory computer readable medium storing a bitstream that is generated by an encoding method, the encoding method comprising:
receiving a polygon mesh comprising at least one crease;
determining one or more predictors to predict a vertex of the at least one crease, each predictor corresponding to a vertex connected to a last previously encoded vertex in the at least one crease; and
generating the bitstream comprising the polygon mesh and the one or more predictors.
